(19) United States
(12) Patent Application Publication
(10) Pub. No.: US 2020/0233254 A1
(43) Pub. Date: Jul. 23, 2020

(54) Cholesteric displays employing a substrate with mirror surface

(71) Applicant: Yao-dong Ma, Frisco, TX (US)

(72) Inventor: Yao-dong Ma, Frisco, TX (US)

(21) Appl. No.: 16/350,822

(22) Filed: Jan. 17, 2019

(51) Int. Cl. G02F 1/137; G02F 1/1343; G02F 1/1335; G02F 1/1333

(52) U.S. Cl. CPC G02F 1/13718; G02F 1/13439; G02F 2203/02; G02F 1/133528; G02F 1/133305; G02F 1/133514

(57) ABSTRACT

The present invention relates to a reflective liquid crystal display, more specifically, to a cholesteric liquid crystal display employing a TFT substrate with mirror pixel electrode array to achieve ultra-high reflectivity. The display provides not only with video speed motion pictures but also with excellent paper-like bistable images.

### FIELD OF THE INVENTION

The present invention relates to a reflective liquid crystal display, more specifically, to a cholesteric liquid crystal display employing a substrate with mirror surface to achieve ultra-high reflectivity. The display provides not only with video speed motion pictures but also with excellent paper-like bistable images.

### BACKGROUND OF THE INVENTION

Cholesteric liquid crystal displays are characterized by the fact that the pictures stay on the display even if the driving voltage is disconnected. The bistability and multistability also ensure a completely flicker-free static display and have the possibility of infinite multiplexing to create giant displays and/or ultra-high resolution displays. In cholesteric liquid crystals, the molecules are oriented in helices with a periodicity characteristic of material. In the planar state, the axis of this helix is perpendicular to the display plane. Light with a wavelength matching the pitch of the helix is reflected and the display appears bright. If an AC-voltage is applied, the structure of the liquid crystals changes from planar to focal conic texture. The focal conic state is predominately characterized by its highly diffused light scattering appearance caused by a distribution of small, birefringence domains, at the boundary between those domains the refractive index is abruptly changed. This texture has no single optical axis. The focal conic texture is typically milky-white (i.e., white light scattering). Both planar texture and focal conic texture can coexist in the same panel or entity. This is a very important property for display applications, whereby the gray scale can be realized.

Current cholesteric displays are utilizing “Bragg reflection”, one of the intrinsic properties of cholesterics. In Bragg reflection, only a portion of the incident light with the same handedness of circular polarization and also within the specific wave band can reflect back to the viewer, which generates a monochrome display. The remaining spectrum of the incoming light, however, including the 50% opposite handedness circular polarized and out-off Bragg reflection wave band, will pass through the display and be absorbed by the black coating material on the back substrate of the display to ensure the contrast ratio. The overall light utilization efficiency is rather low. The Bragg type reflection gives an impression that monochrome display is one of the distinctive properties of the ChLCD.

U.S. Pat. No. 5,796,454 introduces a black-and-white back-lit ChLC display. It includes controllable ChLC structure, the first circular polarizer laminating to the first substrate of the cell which has the same circular polarity as that of the liquid crystals, the second circular polarizer laminating to the second substrate of the cell which has a circular polarity opposite to the liquid crystals, and a light source. The black-and-white back-lit display is preferably illuminated by a light source that produces natural “white” light. Thus, when the display is illuminated by incident light, the circular polarizer transmits the 50% component of the incident light that is right-circularly polarized. When the ChLC is in an ON state, the light reflected by the ChLC is that portion of the incident light having wavelengths within the intrinsic spectral bandwidth, and the same handedness; the light portion that is transmitted through the ChLC is the complement of the intrinsic color of ChLC. The transmitted light has right-circular polarization, however, it is thus blocked by left-circular polarizer. Therefore, the observer will perceive that region of the display to be substantially black. When the display is in an OFF state, the light transmitted through the polarizer is scattered by the ChLC. The portion of the incident light that is forward-scattered is emitted from the controllable ChLC structure as depolarized light. The left-circularly polarized portion of the forward-scattered light is transmitted through the left-circular polarizer, thus, is perceived by an observer. The black-and-white display, in '454 patent, is generated by back-lit component and the ambient light is nothing but noise.

U.S. Pat. No. 6,344,887 introduces a method of manufacturing a full spectrum reflective cholesteric display, herein is incorporated by reference. '887 teaches a cholesteric display employing polarizers with the same polarity as liquid crystals. The display takes advantages of two reflections: Bragg reflection (the reflection) and metal reflection (the second reflection). The display utilizes a circular polarizer and a metal reflector film positioned on the backside of the display to guide the second component of the incoming light back to the viewer.

U.S. Pat. No. 6,873,393 introduces a method of fabricating a black and white or color cholesteric display without using Bragg reflection, herein is incorporated by reference. '393 teaches a cholesteric display employing front polarizer with the opposite polarity to that of liquid crystals. The function of the display cell structure is merely a light shutter to switch the incident light ON and OFF. In the black-and-white display mode, the white state is achieved from the metal reflection in the cholesteric planar texture area; and the black state is obtained by cholesteric's depolarization effect and polarizer's filtration effect in the cholesteric focal conic texture area. In the full color mode, the full color state is created by the metal reflector and the micro-color filter in the cholesteric planar texture area; and the black state is realized in the cholesteric focal conic texture area.

U.S. Pat. No. 7,564,518 introduces a reflective cholesteric display employing two circular polarizers. The front circular polarizer has a predetermined polarity that is opposite both to the Bragg reflection of the display and to the back reflective circular polarizer. An absorptive weak polarizer with high transmittance is adopted in the display system. In the black-and-white display mode, the white state is achieved in the cholesteric focal conic texture area; and the black state is obtained in the cholesteric planar texture area. In the full color mode, the full color state is created by the micro-color filter in the cholesteric focal conic texture area; and the black state is realized in the cholesteric planar texture area.

### SUMMARY OF THE INVENTION

It is the primary objective of the present invention to realize an ultra-bright paper-like display.

It is another objective of the present invention to utilize a display structure with a mirror pixel electrode array to achieve maximum optical reflectivity.

It is also another objective of the present invention to utilize a display structure with a translucent back substrate.

It is again another objective of the present invention to make a display structure without polarizer film lamination.

It is also another objective of the present invention to make a display structure with a single polarizer.

It is still another objective of the present invention to create a bright optical state in display's focal conic texture.

It is yet another objective of the present invention to create a dark optical state in display's planar texture.

It is still another objective of the present invention to create a dark optical state in display's field-induced nematic texture.

It is also another objective of the present invention to obtain a black-and-white display.

It is again another objective of the present invention to accomplish a full color display.

It is the final objective of the present invention to achieve a video motion picture and static image hybrid display.

### BRIEF DESCRIPTION OF THE DRAWINGS

FIG. 1 illustrates a schematic structure of a bistable black-and-white cholesteric display.

FIG. 2 illustrates a schematic structure of a monostable black-and-white cholesteric display.

FIG. 3 illustrates a schematic structure of another bistable black-and-white cholesteric display.

FIG. 4 illustrates a schematic structure of an actively addressed full color cholesteric display.

FIG. 5A illustrates a schematic structure of a TFT substrate.

FIG. 5B illustrates a schematic sectional structure of a TFT substrate.

### DETAILED DESCRIPTION OF THE INVENTION

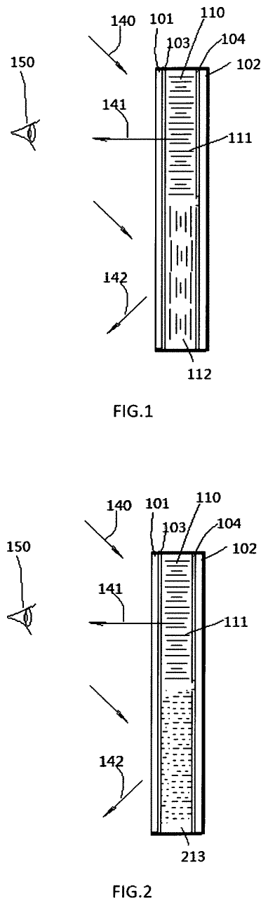

Referring first to FIG. 1, illustrated is a bistable black-and-white cholesteric display structure. The liquid crystal layer 110, including at least one stable focal conic texture area 111 and at least one stable planar texture area 112, is positioned between the transparent front substrate 101 with a transparent common electrode 103 and the translucent back substrate 102 with mirror pixel electrodes 104 to form a cell structure with the thickness in the range of 2-10 microns, more preferably, 2.5-3.5 microns. The front substrate can be made of glass or plastic with the thickness in the range of 0.1-1.1 mm while the back substrate can be made of glass, plastic or metal layer with the same thickness range as the front substrate. A polyimide nano-coating may be applied to at least one substrate as an alignment layer of the liquid crystal and single rubbing might be necessary for better alignment.

The display works in an optical ON state when the liquid crystal layer 110 is addressed in a focal conic texture area 111. The slant incoming light 140 with its incident angle at least 45° to the normal direction of the display, passing through the transparent front substrate 101, is scattered into a diffusing light. Roughly 5% of it will be back-scattered to the viewer and 95% of it becomes forward-scattered light. According to Snell's law, the light with 45° incident angle turns out an angle of refraction around 30° when it reaches the liquid crystals. As the forward-scattered light component hits on the mirror electrode 104, more than 90% of it will be effectively reflected back to the viewer. As a result, both of the back-scattered portion and the forward-scattered portion will finally emerge to the viewer 150 as natural light 141. It is obvious that the brightness of the display or the intensity of the light 141 depends on the following parameters. Firstly, the transmittance of front substrate 101 and ITO conductive electrode 103 should be selected in the range of 90-92% at the wavelength of 550 nm. Secondly, the reflectivity of mirror electrode should be in the range of 90-95%. In this viewpoint, Aluminum and Silver thin film deposition can be used as the mirror electrode. Therefore, the total reflection can reach approximately 75% of the incoming light, which is almost as twice as that of a piece of newspaper.

Accordingly, the display works in an optical OFF state when the liquid crystal layer 110 is addressed in a planar texture area 112. The slant incoming light 140, passing through the transparent front substrate 101, will be Bragg-reflected by the liquid crystal, and the remaining light component be further bounced back on the mirror surface in a way of specula reflection to form the light 142. Based on the law of specula reflection wherein the angle of reflection equals to the angle of incidence, if the viewer 150 looks at the display normally, there will be no light that can be discerned. On the other hand, since it has been formulated in a very weak visible color, for instance, a dim red tint at normal direction, the Bragg reflection of the liquid crystal can be basically neglected. Therefore, the display takes on a sufficient black optical state in the planar texture area.

Like a digital mirror display (DMD) in projection industry, the present invention takes the advantage of the specula reflection of the mirror surface of the display substrate, which differentiates the reflection angle of the outward light and the optic angle of the viewer. Practically, the display can be of a passive matrix substrate (PMLCD) or an active matrix TFT substrate (AMLCD) as long as there is a mirror electric array patterned on the back substrate. In order to eliminate the interlayer optical loss, the inner mirror surface of the metal reflector is absolutely necessary to ensure the black dark state in planar texture area and the bright white state in the focal conic texture area. It is well known in the art that the focal conic texture is an ideal light diffuser to both the incident light and the specula reflection from the mirror.

Turning now to FIG. 2, illustrated is a monostable black-and-white cholesteric display structure. The liquid crystal layer 110, including at least one stable focal conic texture area 111 and at least one unstable field-induced nematic texture area 213, is positioned between the transparent front substrate 101 with a transparent common electrode 103 and the translucent back substrate 102 with mirror pixel electrodes 104 to form a cell structure with the thickness in the range of 2-10 microns, more preferably, 2.5-3.5 microns. The front substrates can be made of glass or plastic with the thickness in the range of 0.1-1.1 mm while the back substrate can be made of glass, plastic or metal with the same thickness range as the front substrate.

The display works in an optical ON state when the liquid crystal layer 110 is addressed in a focal conic texture area 111. The slant incoming light 140, passing through the transparent front substrate 101, is scattered into a diffusing light, wherein roughly 5% of it will be back-scattered to the viewer and 95% of it become forward-scattered light. As the forward-scattered light component hits on the mirror electrode 104, more than 90% of it will be effectively reflected toward the viewer. As a result, both of the back-scattered light and the forward-scattered light will finally emerge to the viewer 150 as the natural light 141.

Accordingly, the display works in an optical OFF state when the liquid crystal layer 110 is addressed in a field-induced and field-maintained nematic texture area 213. This texture is unstable due to the fact that if the field is switched off abruptly, the ChLC will return to the planar texture; and if the field is switched off slowly on the other hand, the ChLC will return to the focal conic texture. As shown in FIG. 2, the slant incoming light 140, passing through the uniaxial conoscopic liquid crystal 213, will be substantially bounced back on the mirror surface in a way of specula reflection to form the light 142. Based on the law of specula reflection wherein the angle of reflection equals to the angle of incidence, if the viewer 150 looks at the display normally, there will be no light that can be discerned. Therefore, the display takes on sufficient black in the field-induced nematic texture area.

Unlike the traditional ChLCD wherein both the focal conic texture and the field-induced nematic texture exhibited dark optical OFF state due to a black coating attached onto the backside of the display substrate, the present invention introduces a novel working mode: focal conic texture works as the bight optical ON state, while the planar texture (as shown in FIG. 1) and the field-induced nematic texture (as shown in FIG. 2) take on the dark optical OFF state.

As a result of the monostable mode, the volatility of the field-induced nematic texture as the optical OFF state and the stability of the focal conic texture as the optical ON state construct a cardinal rule of the video speed cholesteric display of the present invention.

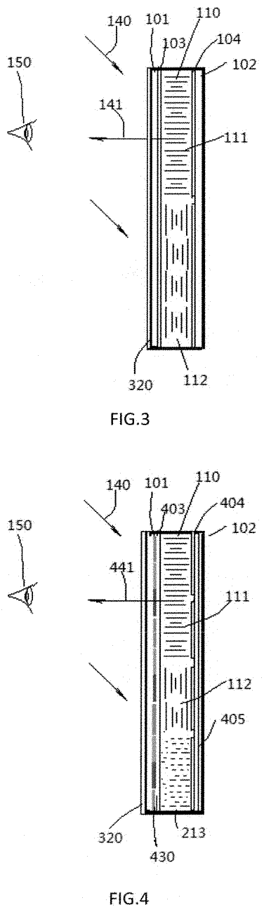

Turning now to FIG. 3, illustrated is a reflective black-and-white cholesteric display structure with a front elliptical polarizer 320. The thin film polarizer can be made of an aligned polymeric nematic liquid crystal as the first layer (1 micron) and a lyotropic liquid crystal (LLC) polarizer (dry thickness 0.1-0.6 micron) as the second layer with a suitable optical axis angle each other, plus a top protection layer with the total thickness less than 20 microns. The thin films are coated consequently onto the front substrate 101. In U.S. Pat. No. 6,847,420, the present applicant describes the formulation and the coating process of the LLC polarizer, herein incorporated by reference. The crystalline polarizer film can be formed, according the present invention, from a nematic phase LLC solution containing 12.5% mixture of dyes (Vat Blue 4; bis-benzimidazole-[2,1-a:1′2′b′]anthra[2,1,9-def:6,5,10-d′e′f′]diisoquinoline-6,9-dion; Vat Red 15 in the ratio 5.2:2:1). The LLC is transferred into an insoluble form after being treated with Barium ions. The thickness of the crystalline film is about 100 nm. Since the crystalline film is a highly ordered anisotropic film, it may simultaneously work as an alignment layer for the liquid crystal. Suitable organic materials include indanthrone (Vat Blue 4), dibenzoimidazol 1,4,5,8-naphthalenetetracarboxilic acid (Vat Red 14), dibenzoimidazole 3,4,9,10-perylentatracorboxilic acid, quinacridone (Pigment Violet 19), or other materials. The derivatives of the above listed materials or their mixtures form stable lyotropic liquid crystal phase.

As addressed in a focal conic texture 111, the display works in an optical ON state. The incident light 140 reaches the elliptical polarizer 320 and converts into circular polarization. When it passes through the ChLC cell with focal conic texture 111 and is depolarized by the scattering effect of the LC material into a non-polarized light. As the neutral non-polarized light hits on the mirror electrode, it will be reflected out of the cell structure to form a linear polarization 341. It is noticed that the brightness of the display or the intensity of the light 341 depends on the following parameters. Firstly, the transmittance of front substrate 101 and ITO conductive electrode 103 should be selected in the range of 90-92% at the wavelength of 550 nm. Secondly, the reflectivity of mirror electrode should be in the range of 90-95%. Thirdly, the transmission of the elliptical polarizer film should be as high as possible, for example, 64%. Therefore, the total reflection can reach up to 50% of the incoming light.

Accordingly, the display works in an optical OFF state when the liquid crystal layer 110 is addressed in a planar texture area 112. The incident light 140 reaches the elliptical polarizer 320 and converts into circular polarization, for example, right handed (RH) polarization. It will proceed to pass through the liquid crystal, and then be further bounced back on the mirror surface which introduces a phase-shift to form a circular polarization with an opposite handedness, i.e., left handed (LH) polarization. Finally, the backward LH component will be substantially absorbed by the front polarizer 320. Due to the attenuations of both the front elliptical polarizer and the specula reflection, there would be no light discerned by the viewer 150.

In U.S. Pat. No. 7,564,518 the present applicant describes a weak polarizer film with high transmission (44%-70%) and high polarization efficiency for the cholesteric display and the related lamination structure, herein incorporated by the reference.

Turning now to FIG. 4, illustrated is a sectional structure of a full color display wherein an absorptive color filter 430 is deposited on the front substrate 101 and a common ITO electrode 103 is sputtered on the top of the color filter layer. The micro color filter array, corresponding to the sub-pixel of the dotted mirror, is of a red, green and blue or red, green, blue and white patterning. In the reflective mode, the thickness of the color filter is usually in the range of 0.4-0.8 micron, more preferably 0.6-0.7 micron. Furthermore, an elliptical polarizer layer 220 is positioned at the front side of the front substrate 101 and a TFT active matrix 404 is fabricated on back substrate 102 respectively.

As shown in FIG. 4, the TFT substrate allows the mirror surface 405 deposited on the outside of the substrate. Due to the fact that all the data electrodes and the scan electrodes are made of metal and the transmittance of the ITO pixel electrode is sufficiently high, which means that the resistivity of the ITO can be 200-300Ω/□, so that the conventional TFT fabrication process can be adopted. Furthermore, the mirror surface can be embedded in the middle of the TFT back substrate, for instance, the storage capacitor can be made of Aluminum and enlarged into the mirror array structure; and furthermore, the whole TFT back substrate can be made of a mirror metal foil, for example, a stainless steel thin film to make a bendable TFT display. The mirror electric TFT array also allows the back substrate to be a translucent plastic substrate, for example, polyimide to make a flexible cholesteric TFT display.

As in above-mentioned embodiment, the optical OFF state displays in the planar texture area 112 and the field-induced nematic texture area 213; and the full color optical ON state displays in the focal conic texture area 111 respectively, according to the waveform of the TFT signals. When the TFT panel is addressed in the video frame rate, for example, 60 frames per second, the cholesteric display works in the monostable mode, wherein the field-maintained focal conic texture 111 exhibits full color optical ON state and field-induced nematic texture 213 shows black optical OFF state. The response time from focal conic to field-induced nematic or vice versa is normally less than 5 ms. In this case, the storage capacitor plays an important part to maintain a suitable voltage level during the 16.7 ms frame time period till the next frame signals refreshing. For a traditional motion picture mode wherein the frame rate is 30 frame/second, the refresh period 33.3 ms will be very spacious for 5 ms response time of the monostable display. Please note that the planar texture area 112 and the field-induced nematic texture area 213 could be coexistent at the same frame content since TFT circuit can be of localized addressing wherein the planar texture of the last frame remains intact in the current frame.

When the TFT panel is addressed in the e-book bitable mode, the electric voltage will be removed abruptly from all the pixels of the TFT panel. The focal conic texture will be able to remain the same optical state in the zero-field condition; while the field-induced nematic texture will relax into the planar texture within 50-500 ms. Both the focal conic texture 111 and the planar texture 112 are zero-field long-term stable states. Even in such an e-book mode, a motion picture could be displayed in a predetermined area since TFT circuit can be partially addressed.

The TFT structure on the back substrate will be further described in detail below.

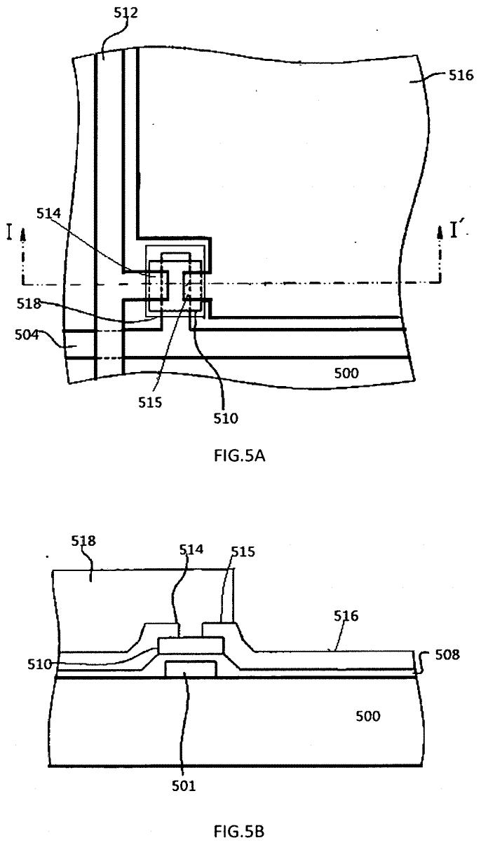

Turning now to FIG. 5, illustrated is a schematic TFT structure on the back substrate. FIG. 5A shows a layout of a TFT substrate according to the present invention, and FIG. 5B illustrates a cross-sectional view of a TFT substrate shown in FIG. 2 along the line I-I′.

As shown in FIG. 5A and FIG. 5B, a gate line 504 which transmits scanning signals from the outside, a gate electrode 501 which is a branch of the gate line 504 and a storage capacitor electrode (not shown) which is parallel to the gate line 504 are formed on a transparent insulating substrate 500 such as glass. A gate insulating layer 508 is formed thereon. A data line 512, which is perpendicular to the gate line 504 and transmits display signals from the outside, is formed on the portion of gate insulating layer 508. A semiconductor and N+ layer 510 is formed on the gate insulating layer 508 and on the gate electrode 501. A source electrode 514 and a drain electrode 515 are formed on the layer 510 with Ohmic contact, and the source electrode 514 is connected to the data line 512. Herein, the gate electrode 501, the source electrode 514, the drain electrode 515, the gate insulating layer 508 and the semiconductor and N+ layer 510 form a TFT, and the channel of the TFT is generated in the portion of the a-Si layer between the source electrode 514 and the drain electrode 515. When the scanning signal is applied to the gate electrode 501 through the gate line 504, the TFT is turned on and the display signal which reaches the source electrode 514 through the data line 512 flows into the drain electrode 515 through the channel in the a-Si layer 510.

A mirror pixel electrode 516 in the pixel area connects directly to the drain electrode 515. In the present invention the pixel electrode and the drain electrode can be the same metal material, for example, Aluminum, formed in one of the same TFT fabrication procedures, which simplifies at least one masking and imaging process. The mirror electrode works as both the electrical component and the optical component, which receives the display signal from the drain electrode 515 to drive liquid crystal molecules and meanwhile has a specula reflection effect to the incoming light of the display. A passivation layer 518 having a black absorbing dye or pigment is formed on the TFT and on the gate insulating layer 508. The passivation layer 518 is made of an organic insulating material having low dielectric constant of 2.4-3.7 and the thickness of 2.0-4.0 microns, which can be also used as a spacer matrix for controlling the cell gap of the cholesteric display.

1. A reflective display system comprising:
a. a front transparent conductive substrate, and
b. a cholesteric liquid crystal layer with at least one controllable planar texture area and one controllable focal conic texture area, and
c. a back conductive substrate with mirror surface,
d. a beam of slant front light,
e. a viewer
wherein the front substrate, the cholesteric liquid crystal layer and the back substrate are juxtaposed to form a display structure; wherein the sight line of the viewer and the front light forms a distinct angle; wherein the front light passing through the focal conic texture area is reflected by the mirror as a diffusive light to form an optical ON state; wherein the light passing through the planar texture area is specula reflected by the mirror to form an optical OFF state, whereby the viewer will observe a bright image.

2. The reflective display system as in claim 1 wherein the mirror surface is Aluminum electrodes array.

3. The reflective display system as in claim 2 wherein the aluminum electrode array is a passive matrix display structure.

4. The reflective display system as in claim 1 wherein the angular difference between the sight line of the viewer and the front light is at least 45°.

5. The reflective display system as in claim 1 wherein the brightness of the optical ON state is approximately 75% of the incoming light.

6. The reflective display system as in claim 1 further including an absorptive color filter layer positioned in the front substrate with thickness in the range of 0.4-0.8 micron.

7. A reflective display comprising:
a. a front transparent conductive substrate, and
b. an elliptical polarizer layer, and
c. a cholesteric liquid crystal layer with at least one controllable planar texture area and one controllable focal conic texture area, and
d. a back conductive substrate with mirror surface,
wherein the front substrate coated with the elliptical polarizer, the cholesteric liquid crystal layer and the back substrate are juxtaposed to form a display structure; wherein the front partial circular polarization passing through the focal conic texture area is reflected by the mirror as a diffusive light to form an optical ON state; wherein the polarization passing through the planar texture area is specula reflected by the mirror and further absorbed by the polarizer to form an optical OFF state, whereby the viewer will observe a bright image.

8. The reflective display as in claim 7 wherein the thin liquid crystal elliptical polarizer is made of a lyotropic liquid crystal dye with dry thickness in the range of 0.1-0.6 micron and polymeric nematic liquid crystal with the thickness in the range of 0.5-1 micron.

9. The reflective display as in claim 7 wherein the front elliptical polarizer is a weak absorptive polarizer with single transmission in the range of 44%-70%.

10. The reflective display as in claim 7 wherein the optical OFF state is created by both mirror's phase-shift extinction and mirror's specula reflection to the incoming polarization.

11. The reflective display as in claim 7 wherein the brightness of the optical ON state is approximately 50% of the incoming light.

12. The reflective display as in claim 7 wherein the display is a translucent plastic substrate display.

13. A monostable reflective display comprising:
a. a front transparent conductive substrate, and
b. an elliptical polarizer layer, and
c. a cholesteric liquid crystal layer with at least one field-induced nematic texture area and one controllable focal conic texture area, and
d. a back active matrix substrate with mirror surface, and
e. a video rate driving waveform,
wherein the front substrate coated with the elliptical polarizer, the cholesteric liquid crystal layer and the back substrate are juxtaposed to form a display structure; wherein the front partial circular polarization passing through the focal conic texture area is reflected by the mirror as a diffusive light to form an optical ON state; wherein the polarization passing through the field-induced nematic texture area is specula reflected by the mirror and further absorbed by the polarizer to form an optical OFF state, wherein the driving waveform addresses the optical ON and OFF states at video frequency, whereby the viewer will observe a bright motion picture.

14. A monostable reflective display as in claim 13 wherein the mirror surface is the Aluminum pixel electrode connected to the Aluminum drain electrode.

15. A monostable reflective display as in claim 14 wherein Aluminum pixel electrode and the drain electrode are fabricated in the same mask and patterning process.

16. A monostable reflective display as in claim 13 wherein the mirror surface is a stainless steel substrate.

17. A monostable reflective display as in claim 13 wherein the mirror surface is the Aluminum deposition layer at the back side of the display.

18. A monostable reflective display as in claim 13 wherein the display is a full color display with the refresh speed at least 30 frames per second.

19. A monostable reflective display as in claim 13 wherein the display is a full color e-book display.

20. A monostable reflective display as in claim 13 wherein the display is a monostable and bistable hybrid display.
